(19) United States
(12) Patent Application Publication
(10) Pub. No.: US 2004/0034715 A1
(43) Pub. Date: Feb. 19, 2004

(54) Content based routing devices and methods

(76) Inventors: Steven Dawson, Menlo Park, CA (US); David Stringer-Calvert, Santa Clara, CA (US); Patrick Lincoln, Woodside, CA (US)

Correspondence Address: Moser Patterson & Sheridan, Suite 100, 595 Shrewbury Avenue, Shrewbury, NJ, 07702, US

(21) Appl. No.: 10/416,114

(22) PCT Filed: Dec. 6, 2000
(86) PCT No.: PCT/US00/42674

(51) Int. Cl. G06F 15/173

(52) U.S. Cl. 709/238

(57) ABSTRACT

Content based routing and broadcasting methods and devices (10) utilizing routers (100) programmed to analyze the non-address portion (701) of data packets (700) and to route the packets (700) accordingly are described as are their application in support of blind broadcasting.

This application claims the benefit of U.S. provisional application No. 60/247184 incorporated herein by reference in its entirety.

### FIELD OF THE INVENTION

The field of the invention is information management and distribution networks.

### BACKGROUND OF THE INVENTION

As the Internet and other networks become a ubiquitous source of news and information, managing the distribution of such information to interested recipients has become a major problem. Current common methods for accessing information stored in the network involves the user (or an automated process acting on the user's behalf) actively searching out the required information, either on-demand (for example a user clicking around the CNN website) or pro-actively (for example a search engine crawling the web for information on prehistoric man, for future retrieval by interested parties).

In the realm of traditional news and information distribution mechanisms this computer based approach most closely resembles that of printed media, for example books and newspapers. Within this method of information distribution, a consumer of information visits a repository of information (a bookstore or library) and is able to browse the available information, potentially to make a decision on purchasing a copy of the information.

The current Internet suffers a significant bottleneck in terms of overload of the computing resources of popular web sites and other information sources. Taking our analogy of a web site to a library, with a popular web site we have the equivalent of a library with millions of visitors per day—that number expanding at an ever increasing rate. Building the necessary computer equivalent of additional parking lots and bookshelves for the web site is an enormous undertaking, and not a scalable solution to the problem of information management and distribution on a global scale. Several methods and devices are available in the art for solution to the scalability problem, but they center around the computational equivalent of building additional branch libraries—for example caching, replication, load balancing, and so on.

During the twentieth century, the printed word became a less important method of information distribution with the advent of radio and television. This method of information distribution follows a significantly different paradigm, where information is ‘broadcast’—that is transmitted by some party into the world with no particular prejudice regarding the destination or recipients of the information. A recipient is not required to connect to a website or visit a library, rather the information is available to any party with the required equipment enabled to receive the broadcast.

The equivalent of television is also known in computer networks, and is analogous to ‘multi-cast’, where information is transmitted on the network with a special destination address. This address does not represent a particular network node, but instead represents the equivalent of a television channel, to which interested network nodes can subscribe (by using the Internet Group Management Protocol) in much the same way as a television set can be tuned to a desired station.

It is also known in the art how to identify a message as a “broadcast” message by providing it with a “broadcast” IP address which does not correspond to a particular device. Such “directed broadcasts” are transmitted towards a group (known as a ‘subnet’) of devices. Such directed broadcasts are generally frowned upon (and hence filtered out by most router nodes) in the Internet, as they can be subverted as a mechanism in denial of service attacks. For example, a node ‘A’ can send one directed broadcast packet to a subnet of 250 nodes, with a forged originating address of node ‘B’. For certain protocols, all 250 nodes on the chosen subnet will respond to node ‘B’, and could overload that node, causing legitimate use of the node to be locked out (hence ‘denial of service’).

With both the traditional and computer network approaches outlined above, the core problem of information management can be seen as how to locate relevant content. You must know where and when to go for information (which library/web site, which multi-cast stream/television frequency). There is a need in the art for a new method of information distribution to address this issue.

### SUMMARY OF THE INVENTION

The present invention is directed to the blind broadcasting of information across computer networks via content based routing methods and devices. In particular, the use of routers programmed to analyze the non-address portion of data packets and to route the packets accordingly are disclosed herein as is their application in support of blind broadcasting.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic view of a routing according to the inventive subject matter.

FIG. 2 is a schematic view of a packet having both address and non-address portions.

### DETAILED DESCRIPTION

Methods and devices related to the broadcasting and routing of data within computer networks are known. However, such previously known methods and devices are insufficient to support broadcasts of information across a large network comprising numerous sub-networks. Such “true” broadcasts, at least as used herein, may better be referred to as “blind” broadcasts in that what is contemplated is the transmission of information from a source to one or more recipients without requiring that the source or broadcaster have prior knowledge of the recipients. Thus, as used herein, “blind broadcasting” is intended to describe a type of communication wherein a broadcasting computer transmits a message without necessarily having prior knowledge of the devices which will be the ultimate message recipients, and possibly with the transmission being done in a manner that allows a recipient to receive any messages which may be of interest to the recipient.

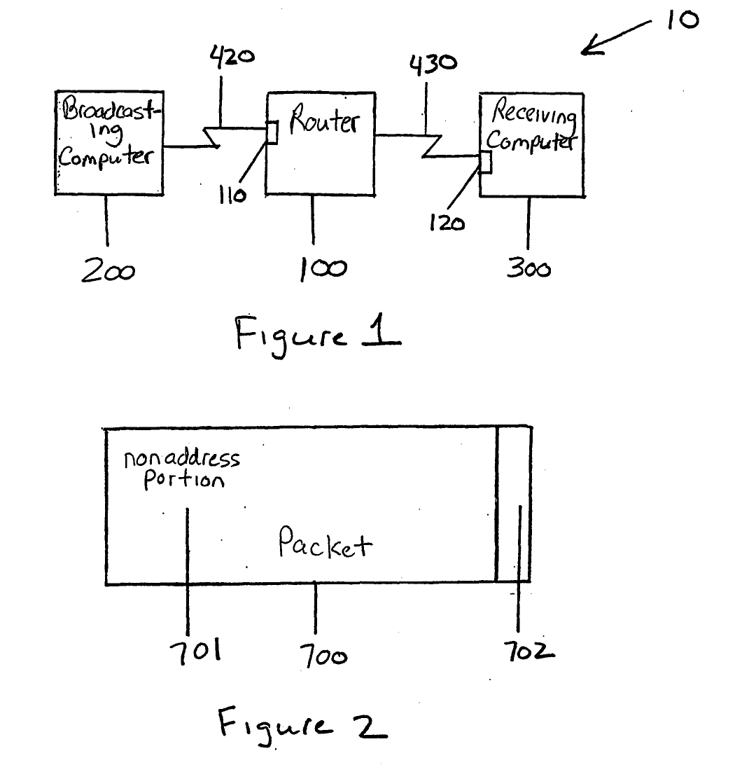

In FIG. 1, a routing system 10 which supports blind broadcasting comprises at least one router 100 programmed to route a packet 700 (see FIG. 2) by analyzing a non-address portion 701 of the packet, and routing the packet at least partially based on the analysis. In a preferred embodiment, the router 100 has at least one input port 110 and at least one output port 120, and the router is programmed to associate at least one data packet content type with the output port, to receive data packets through the input port, to analyze a non-address portion of the data packets to associate a content type with each packet, and to transmit via the output port 120 only those packets whose associated content type corresponds to the content type associated with the output port 120. In still more preferred embodiments, a plurality of content types will be associated with the output port with the content types corresponding to all the content types of interest to any computers and/or routers communicatively coupled to the router via the output port. In such embodiments packets may be broadcast and re-broadcast through a series of routers until they reach an appropriate network segment or destination computer.

The system 10 of FIG. 1 further comprises a broadcasting computer 200 coupled to the router via a first communications channel 420 coupled to the router's input port 110, a receiving computer 300 coupled to the router via a second communications channel 430 coupled to the router's output port. It should be noted that the terms “broadcasting computer” and “receiving computer” as used herein are not limited to any particular number or arrangement of computers or other devices but consist of any device or group of devices on which information can be stored and from which information can be retrieved. Thus, a “computer” may comprise a single device, a group of devices, a number of devices networked together, or a network comprising multiple sub-networks. A partial list of potential devices may include server farms, desktop workstations, hand-held devices such as cell phones, personal data assistants, and even appliances such as toasters and washing machines.

The first broadcasting computer 10 is programmed to place data packets that are not addressed to the receiving computer on the first communication channel 420. The router 100 is programmed to copy at least a portion of at least some of the data packets onto the second communications channel 430. The receiving computer is programmed to receive at least some of the data packets on the second communications channel 430.

A number of addressing variations are possible which support a blind broadcast of packets (the routing of packets received from the broadcasting computer are routed to the receiving computer without requiring that the broadcasting computer include the address of the receiving computer in any of the packets). The variations can be characterized by whether packets being transmitted from the broadcasting computer to the router is by inclusion of the router address in the packets or not, and whether transmission of packets from the router to the receiving computer is by inclusion of the router address in the packets or not. Any combination is possible so long as the decision to route packets in a manner that the packets can be picked up by the receiving computer is at least partially based on the results obtained by analyzing the contents of the packets. Thus, in some embodiments data packets placed on the first communications channel by the at least one broadcasting computer are addressed to the router while in other embodiments the portions of the data packets copied onto the second communications channel by the router are addressed to the at least one receiving computer. In still other embodiments the data packets placed on the first communications channel by the at least one broadcasting computer are not addressed to the router, and the portions of the data packets copied onto the second communications channel by the router are not addressed to the at least one receiving computer.

Referring again to FIG. 2, each packet 700 may comprise an address portion 702 in addition to and separate from the non-address portion 701 so long as routing of the packet is only partially based on the contents of the address portion 702. If a packet has an address portion 702 and the address portion 702 of each packet includes a port number, the routing of the packet 700 may be at least partially based on the port number. Similarly, if the address portion 702 contains a type indicator that is related to the content type of the non-address portion of the packet, such an indicator may be used in support of, but not in place of the analysis of the non-address portion 701 of the packet 700 and routing of the packet 700.

It is also contemplated that a given packet 700 may include an encapsulated address in the “non-address” portion 701 of the packet. Although it is preferred to view the non-address portion 701 of the packet as the portion in which no address information, encapsulated or not, is found, having an encapsulated address is permissible so long as the analysis of the non-address portion 701 and subsequent routing of the packet 700 is not based solely on the encapsulated address.

In some embodiments the router 100 may have information regarding the content that the receiving computer 300 is programmed to accept and handle, and may use such information as part of the analysis of the non-address portion of a packet or in determine how to route such a packet. If it is to have such information, it is preferred that the receiving computer communicate such information to the router. Thus, both the router and receiving computer would be programmed to communicate with each other in regard to the content of interest to the receiving computer.

Similarly, one router in a chain may communicate with its neighboring routers such that packets having content that is of interest to a device separated from the broadcasting computer by a series of routers may still receive the packet as a result of the intervening routers knowing that the receiving computer is interested in the contents of the packet. Thus, the receiving computer 300 may itself be a router. Further, if a plurality of intervening routers communicate the information requirements of a plurality of receiving computers, information that is blind broadcast on the network may be dropped by any of the intervening routers if it can be determined that no subsequent routers or receiving computers communicatively coupled thereto have interest in receiving the said information.

It should be noted that router 100, broadcasting computer 200, and receiving computer 300 need not be a particular combination of hardware and/or software. Any hardware/software combination which satisfies the description contained herein or permits the device to perform the steps described herein may be used for router 100, broadcasting computer 200, and/or receiving computer 300. Similarly, communication channels 420 and 430 may comprise a simple cable coupling router 100 to computers 200 and 300, or may themselves comprise a plurality of networks utilizing a variety of communication mediums to interconnect a variety of devices.

Of particular interest is where “computer” 300 comprises a segment of a network, possibly a segment having a particular geographic location related to the data being transmitted to it.

A preferred method of routing that preferably will utilize the system 10 of FIG. 1 includes the following steps: providing a network having a router, a broadcasting computer, and a receiving computer; causing the broadcasting computer to originate a series of data packets, each data packet having a non-address portion; causing the router to analyze the non-address portion of at least some of the data packets and, if the analysis indicates that the series of packets is of interest to the receiving computer, transmitting copies of each of the series of packets to the receiving computer.

In instances where initial packets in a series are discarded or ignored as not being of interest in regard to the destination computer, the router will need to recover such packets (unless it maintains a store of all packets in a series until the entire series has been analyzed) so as to provide a complete sequence of packets. This can be accomplished by requesting that the broadcasting computer re-send/broadcast the missing packets to the router. Alternatively, and either based on the decision of the router or the requesting computer, the router may provide only subsequent packets (similar in our earlier analogy to joining a television program half way through).

It is contemplated that the methods and devices described herein are applicable regardless of packet content and whether or not a given packet contains an entire data item or only a piece of a data item. Thus, it is contemplated that data items contained in the packets being analyzed and upon which routing will take place may include but are not necessarily limited to executable programs, images, documents or other data files.

If a packet contains executable code, such code may be run on the router and subsequently broadcast on to other routers/computers/network segments, or may simply be run on the router without continued routing/broadcasting of the packet (In such an instance the router will have essentially routed the packet to itself). The execution of code contained within the packet may contribute to the routing decision with respect to the current packet, and may also affect the future behavior of the router with respect to routing of future packets.

It is contemplated that in some embodiments the routing performed by router 100 will be state dependent in that it may change over time, and the current state at any given time may be dependent on a prior state.

It should be noted that it is not necessary for all routers in a communication network to be aware of blind broadcasting to obtain utility from the present invention. A subset of all routers in the communication network may embody the methods disclosed herein, and thus be communicatively coupled in an ‘overlay network’, where detail of how packets traverse between blind broadcast enabled routers can be ignored. One preferred embodiment based on such an overlay network is where the blind broadcast aware routers comprise all or part of an “edge” network.

An edge network is one that includes more than 20 nodes, at least several. of those nodes being physically separated from each other by a distance of at least 1 km, and where the edge network nodes are communicatively coupled via data channels that are faster by at least an order of magnitude than the speed of connection between the edge nodes and at least one or more non-edge network nodes. For example, a typical edge network might be a group of geographically distributed Internet servers connected to each other by relatively high-speed lines (such as dedicated leased lines). A “private edge network” is an edge network whose nodes are under the management and control of a single entity (such as a corporation or partnership, for example). Many edge networks have arisen or been constructed out of a desire to provide improved network infrastructure for delivering content across the Internet to multitudes of geographically diffuse end-users. (See, for example, the methods of Digital Island at http://www.digisle.net/ and Akamai at http://www.akamai.com.) Incorporation of the teachings of the present invention into an edge network creates a low cost approach to leverage the advantages of blind broadcasting without the potentially prohibitive costs involved with re-tooling a large network.

As an example of a particular application of a blind broadcast that might have advantageous uses is broadcasting a sound file comprising a recorded political speech. Analysis of the non-address portions of the packets could identify the packets as containing a sound file. Further analysis could identify it as containing human speech. Further analysis could identify particular words used which in turn could identify the speech as being political in nature, and the particular issues being discussed. A person wanting to make such a speech and wanting to make it available to anyone willing to listen could blind broadcast it. Assuming for the sake of this example that one or more people are interested in reviewing political speeches related to certain topics, they could program that interest, via a suitable interface, into their computer system, their system could communicate that interest to a nearby router, which would communicate it to another router, etc. until it reaches a router which has visibility to the first transmission by the speech maker via a broadcasting computer. The packets which make up the speech could then be forwarded to the people interested in the speech. Embodiments in which specific information relating to each user are maintained on each router are contemplated as well as embodiments in which each router has only enough information to insure that it re-blind broadcasts the packets. It is also contemplated that limitations regarding the breadth of coverage that packets are to be broadcast may need to be enforced as may limitations to the extent which criteria identifying content of interest may be distributed.

What is claimed is:

1. A routing system comprising at least one router programmed to route a packet by analyzing a non-address portion of the packet and routing the packet at least partially based on the analysis.

2. The routing system of claim 1 wherein the router is programmed to:
associate at least one data packet content type with an output port;
receive data packets through an input port;
analyze a non-address portion of the data packets to associate a content type with each packet; and
transmit via an output port only those packets whose associated content type corresponds to the content type associated with the output port.

3. The routing system of claim 2 further comprising:
at least one broadcasting node coupled to the router via a first communications channel;
at least one receiving node coupled to the router via a second communications channel;
wherein the first broadcasting node is programmed to place data packets that are not addressed to the receiving node on the communication channel;
the router is programmed to copy at least a portion of at least some of the data packets onto the second communications channel;
the receiving node is programmed to receive at least some of the data packets on the second communications channel.

4. The system of claim 3 wherein the data packets placed on the first communications channel by the at least one broadcasting node are addressed to the router.

5. The system of claim 3 wherein the portions of the data packets copied onto the second communications channel by the router are addressed to the at least one receiving node.

6. The system of claim 3 wherein the data packets placed on the first communications channel by the at least one broadcasting node are not addressed to the router, and the portions of the data packets copied onto the second communications channel by the router are not addressed to the at least one receiving node.

7. The system of claim 3 wherein the first communications channel and the second communications channel are the same communications channel.

8. The system of claim 3 wherein the first communications channel and the second communications channel are different communications channels.

9. The system of claim 6 wherein the receiving node analyzes packets not specifically addressed to the receiving node for content which the receiving node has been programmed to accept and handle.

10. The system of claim 9 wherein the receiving node is programmed to communicate with the router to identify content of interest for the router to associate with receiving node, the router being programmed to participate in such communications, to associate the identified content of interest with the receiving node, and to at least partially utilize the contents of interest associated with the receiving node to determine which packets are to be copied.

11. A method of routing data across a network comprising:
providing a network having a router, a broadcasting node, and a receiving node;
causing the broadcasting node to originate a series of data packets, each data packet having a non-address portion;
causing the router to analyze the non-address portion of at least some of the data packets, and, if the analysis indicates that the series of packets is of interest to the receiving node, transmitting copies of each of the series of packets to the receiving node.

12. The method of claim 11 wherein, after determining that the copies of packets is of interest to the receiving node, but prior to transmitting copies of each of the series of packets to the receiving node, the router requests that the broadcasting node re-transmit at least some of the series of packets.

13. The method of claim 11 wherein the non-address portions of the series of data packets include all the pieces of a data item, and the data item is executable program an image, or a document.

14. The method of claim 11 wherein the non-address portion of at least one data packet comprises executable code and the router executes the code.

15. The method of claim 14 wherein the decision to transmit the packet is based on the execution of the executable code.

16. The method of claim 14 wherein the decision to transmit further received data packets is based on the execution of the executable code.

17. The method of claim 11 wherein each packet comprises an address portion in addition to and separate from the non-address portion and routing of the packet is only partially based on the contents of the address portion.

18. The method of claim 17 wherein the address portion of each packet comprises a port number, and the routing of the packet is based on the port number but not on any additional address information contained in the address portion.

19. The method of claim 11 wherein the non-address portion contains an encapsulated address, but analysis of the non-address portion and subsequent routing of the packet is not based solely on the encapsulated address.

20. The method of claim 11 wherein the receiving node is itself a router.

21. The method of claim 11 wherein packets are routed to geographic areas associated with the content of the packets.

22. The method of claim 11 wherein the data is selected from the following group: web pages, documents, images, audio, music, and video.

23. The method of claim 11 wherein the routers form an edge network.
